(19) United States
(12) Patent Application Publication
(10) Pub. No.: US 2010/0314469 A1
(43) Pub. Date: Dec. 16, 2010

(54) COMBINED VENTILATOR/GAS VALVE UNIT

(76) Inventors: Thomas Roschke, Dresden (DE); Jörg Köhler, Dresden (DE); Michel Gamot, Arzon (FR)

Correspondence Address: Hildebrand, Christa;Norris McLaughlin & Marcus PA, 875 Third Avenue, 8th Floor, New York, NY, 10022, US

(21) Appl. No.: 12/599,175

(22) PCT Filed: May 5, 2008
(86) PCT No.: PCT/DE2008/000749

§ 371 Date: Aug. 31, 2010

(30) Foreign Application Priority Data
May 8, 2007 (DE) 10 2007 022 008.3

(51) Int. Cl. B05B 7/12; F23D 14/60

(52) U.S. Cl. 239/417.3

(57) ABSTRACT

Disclosed is a combined ventilator/gas valve unit (1) at least comprising a gas valve (2) that is disposed in a housing (2.1), a nozzle (3) located therebehind, and an adjoining ventilator (4) which is provided with a multipart ventilator housing (4.1). According to the invention, the suction side (4.2) of the ventilator housing (4.1) is designed as a nozzle (3) to which the gas valve (2) is fastened.

The invention relates to a combined ventilator/gas valve unit for burners of a modulatable gas heating device, said unit being used for the adaptation to a varying heat loading and for the abrupt switch off of the fuel-gas flow, particularly in gas heating appliances for domestic space heating and hot-water supply.

Against the background of limited fossil fuel resources, averting a change in the climate that would restrict mankind in almost all areas, high-efficiency low-emission gas heating devices are seen to be of special importance in the future. Optimum combustion, i.e. aiming at the desired λ-values, for example, ensures low emission values and a high efficiency of the firing installation.

The desired λ-values are technologically achieved in that the air/gas mixing ratio is typically controlled using a pneumatic interconnection, i.e. pneumatic control of the gas valve dependent on the volumetric air flow rate.

Prior art has DE 103 18 569 B3 and DE 103 61 918, where stepper motors are used for said control. Further solutions are described in WO 2006/000367, DE 10 2004 048 986 and DE 102 20 773, disclosing approaches where in addition to a method for achieving optimum combustion, also the connecting device between the ventilator and the gas valve is subject of the invention.

It is disadvantageous of the aforementioned inventions that they do not offer solutions to economically implement and integrate the described assemblies and control methods.

Further disadvantages of the solutions known in prior art are that if the gas valve is placed laterally the ensemble of ventilator, nozzle and gas valve is very voluminous. Gas heating appliances for domestic space only rarely, or do not at all, offer the required installation space.

Furthermore, due to the number of components needed the tolerance chains are very long so that standard gas heating appliances are less reliable related to a long longevity. In addition, a big number of components requires a big number of manufacture steps so that high costs develop.

Therefore, it is the problem of the invention to propose a combined ventilator/gas valve unit that, first, requires very little space and second, can be manufactured at lower cost. Further, it is a problem of the invention to implement design solutions of the known methods for burner control.

The problem is solved, according to the invention, by a combined ventilator/gas valve unit at least comprising a gas valve that is disposed in a housing, a nozzle located therebehind, and an adjoining ventilator that is provided with a multipart ventilator housing, whereby in a first embodiment of the invention the suction side of the ventilator housing is established as a nozzle to which the gas valve is fastened.

For manufacture reasons the suction side of the ventilator housing is established as housing cover or housing cap.

Preferably, the gas valve is fastened to the suction side of the ventilator housing established as nozzle using fins and/or a threaded joint.

In a particularly preferred embodiment of the invention the suction side of the ventilator housing established as nozzle and at least part of the housing of the gas valve are made as a compact one-part component. Due to the combination of the ventilator housing established as nozzle with the housing of the gas valve not only material can be saved but also the manufacture efforts during assembly are significantly reduced compared to prior art.

Any location of the gas valve or the housing of the gas valve relative to the ventilator housing is theoretically possible, but in practice, the concentric arrangement of the gas valve in the air inflow channel, axial on the suction side, respectively, would be preferred.

According to the invention the nozzle is established as conventional nozzle or as Venturi tube. In the first case, the air flows through the fins that extend between the ventilator housing and the gas valve, arranged radially around the gas valve. The drawn-in air and the gas flow concentrically to each other and only mix within the ventilator. In the second case, that is with the nozzle established as Venturi tube, the gas valve is on the gas outlet side provided with a gas flow guiding device that in the area of combination of the Venturi tube cones directed opposite to each other includes an annular gap, through which the gas is drawn by the air that enters the Venturi tube so that the gas and the air are fed to the mixing space placed upstream of the ventilator. The mixing space is either a volume part of the Venturi tube or a subsequent part between the Venturi tube and the ventilator.

The gas flow guiding device is established as cover or, preferably, as cap.

In a second embodiment of the invention the combined ventilator/gas valve unit comprises at least a gas valve that is disposed in a housing, a nozzle located therebehind, and an adjoining ventilator that is provided with a multipart ventilator housing. Part of the ventilator housing and the housing of the gas valve are, in this case, shaped such that in assembled condition they establish together both the nozzle and a gas flow path entering into the nozzle.

In a particularly advantageous embodiment of the invention the gas valve is built of two housing parts, whereby the first housing part is established by a formed element present in the ventilator housing and the complementary second housing part of the gas valve is established as cover connected to the ventilator housing. Here the cover and that part of the ventilator housing that is covered by the cover, in assembled condition establish together both the nozzle and a gas flow path entering into the nozzle. The formed element can be located at any place in the ventilator housing, but is preferably arranged on the suction side or on a face side of the ventilator housing.

Additionally, differently established top parts can be provided placed before the nozzle to establish various suction-side air flow profiles. The top parts further offer the possibility to integrate sensors in an especially simple manner.

The formed element of the ventilator housing established as first housing part and the cover established as first housing part of the gas valve each are preferably designed as complementary housing halves.

The significant advantages and features of the invention compared with prior art essentially are:
The combination of ventilator housing and nozzle or ventilator housing, nozzle and valve housing or ventilator housing and valve housing of the ventilator/gas valve unit reduces the number of components needed, the tolerance chains, the assembly effort and the space requirement;
The electronic control combination enables to react better, compared with the pneumatic control of the gas valve of prior art, to a change between different gases and gas qualities, especially at little pressure variations;
Using a Venturi tube and the mixing space upstream of the ventilator, the ventilator can be supplied with fuel gas that has already been completely mixed;
The sensors integrated in the valve housing or, for example, in a Venturi tube reliably ensure λ-values desired for the combustion while requiring no additional space;
Use of a threaded joint enables gas valves of different manufacturers to be coupled to the ventilator in a simple and unproblematical way.

The objectives and advantages of the present invention will become apparent upon carefully reading the following detailed description of the here preferred, not limiting exemplary embodiment of the invention in combination with the accompanying drawings of which show:

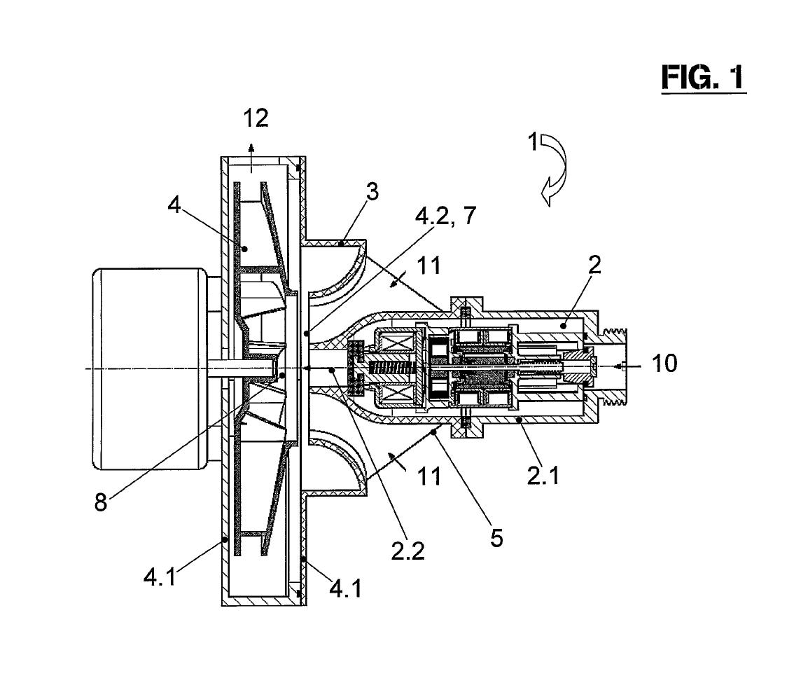

FIG. 1 a cross-section of a combined ventilator/gas valve unit with the suction side of the ventilator housing established as a nozzle, and fins;

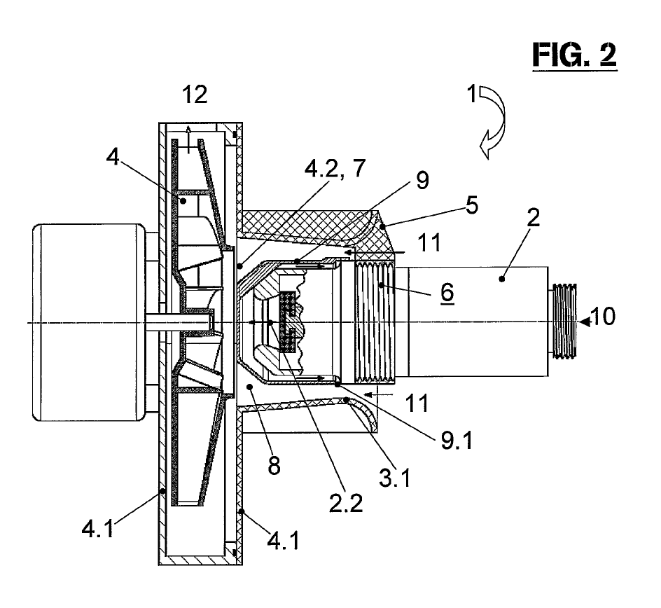

FIG. 2 a cross-section of a combined ventilator/gas valve unit with Venturi tube and gas flow guiding device;

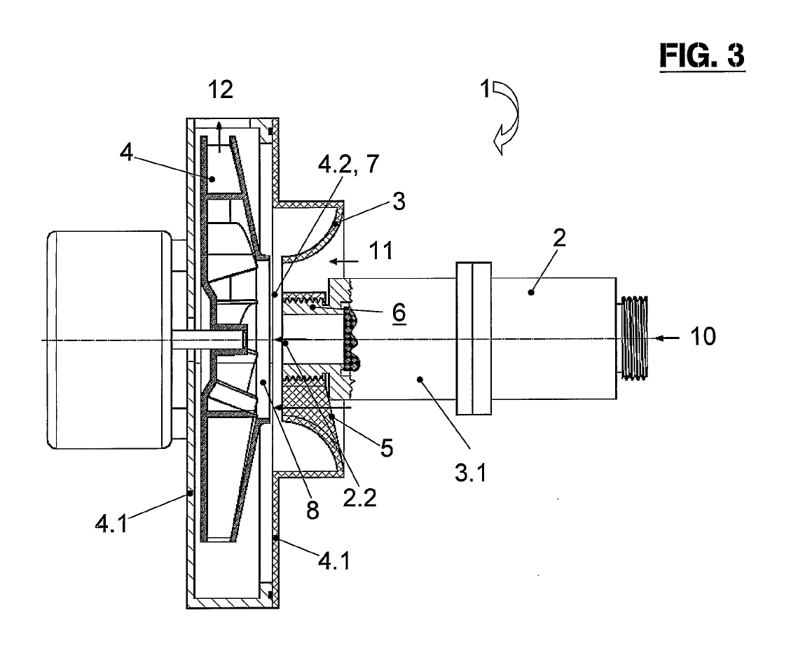

FIG. 3 a cross-section of a combined ventilator/gas valve unit with the suction side of the ventilator housing established as a nozzle and a face-side threaded joint;

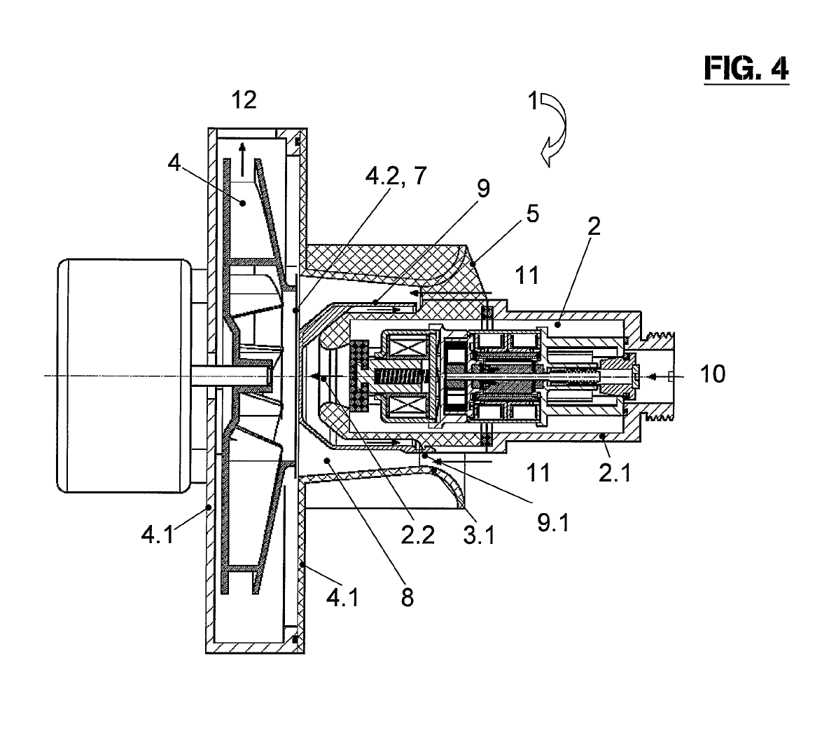

FIG. 4 a cross-section of a combined ventilator/gas valve unit with Venturi tube and gas flow guiding device;

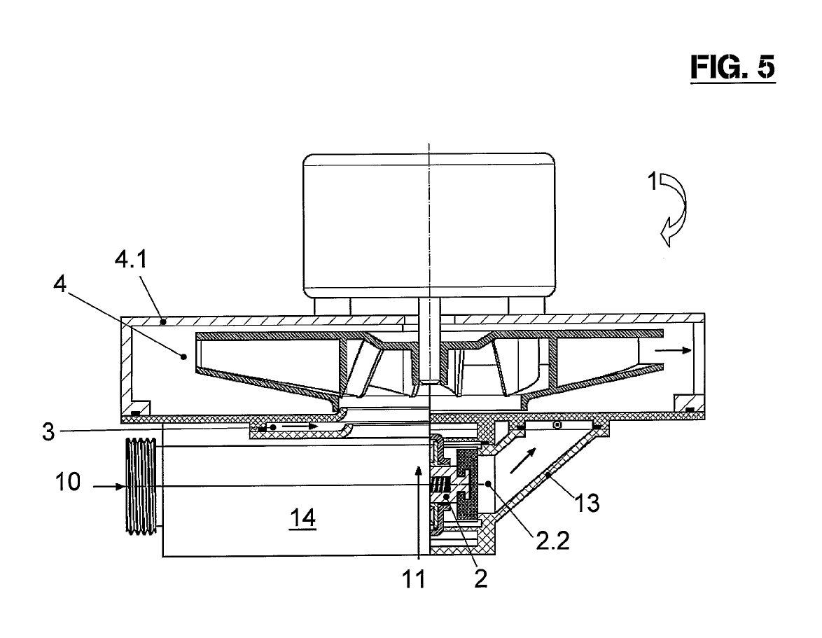

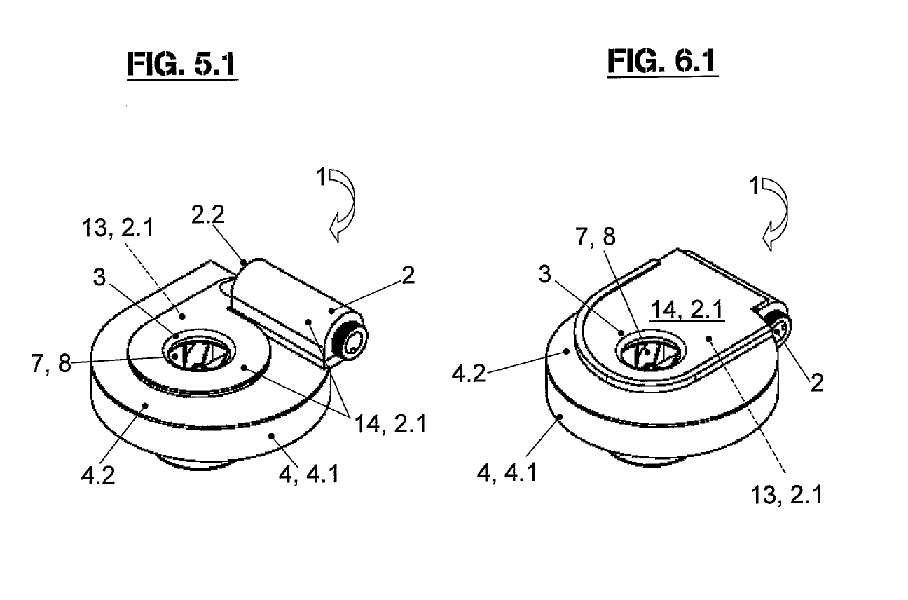

FIG. 5 a cross-section of a combined ventilator/gas valve unit with a gas valve 2 having two housing parts, in a first version of embodiment;

FIG. 5.1 a perspective view of the ventilator/gas valve unit according to FIG. 5;

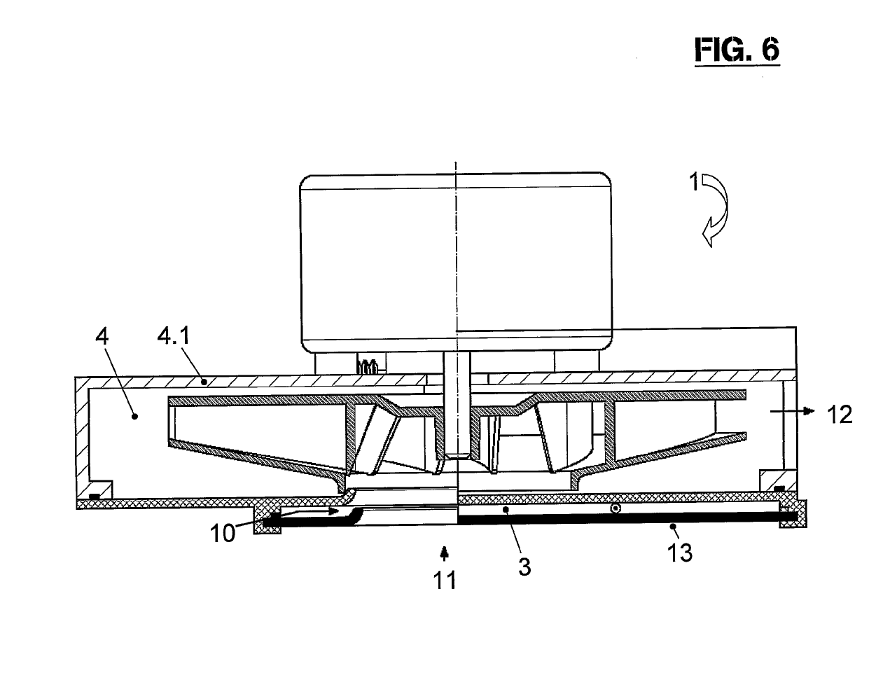

FIG. 6 a cross-section of a combined ventilator/gas valve unit with a gas valve 2 having two housing parts, in a second version of embodiment;

FIG. 6.1 a perspective view of the ventilator/gas valve unit according to FIG. 6.

FIG. 1 illustrates a cross-section of a combined ventilator/gas valve unit 1 with the suction side 4.2 established as nozzle 3 of the ventilator housing 4.1 and fins 5. The combined ventilator/gas valve unit 1 essentially comprises a gas valve 2 provided with a housing 2.1, a nozzle 3 located therebehind, and an adjoining ventilator 4, established as radial ventilator, which is provided with a multipart ventilator housing 4.1. It is characteristic of this embodiment of the invention that the suction side 4.2 of the ventilator housing 4.1 is established as nozzle 3, to which the gas valve 2 is fastened by use of fins 5 that extend between the nozzle 3 and the housing 2.1 of the valve 2. The suction side 4.2 of the ventilator housing 4.1 is formed as cover that is fittable to the complementary second housing 4.1 formed pot-like. The gas valve 2 is arranged concentric within the air inflow channel 7 of the ventilator 4. Whereas the gas 10 passes the gas valve 2 axially, the air 11 is drawn in by means of the nozzle 3 that extends funnel-like around the gas valve 2. The mixing space 8 for the preparation of the fuel gas, which is formed of the gas 10 and the drawn-in air 11, is within the ventilator 4. In a practically oriented embodiment the suction side 4.2 established as nozzle 3 of the ventilator housing 4.1, the fins 5 and the housing 2.1 of the gas valve 2 are made in one part. In the representation according to FIG. 1, however, only the front part of the housing 2.1 of the gas valve 2 directed to the ventilator 4, the fins 5 and the ventilator housing 4.1 are commonly established as one-part component. The gas valve 2 is additionally provided with sensors, not shown in the drawing, for use in a λ-control circuit or in other control circuits of the firing installation. For example, a sensor established as a pressure sensor placed in the valve housing 2.1 can be used as interface to the valve's electronic equipment. The essential advantage of this solution consists in that the assembly effort is lower compared with the solutions known in prior art, as the number of required components could be reduced due to component and functional integration.

Furthermore, the integrated control, or the sensors and further components of the control circuit, respectively, make possible that the combustion runs efficiently, thus enhancing the exhaust gas quality and energy utilization. Gas valves 2 or gas fittings of different manufacturers can be used in the combined ventilator/gas valve unit 1 according to the invention with only the suction side 4.2 established as nozzle 3 of the ventilator housing 4.1 necessarily designed accordingly. From a manufacture-based point of view several ventilator housing covers 4.1 with different connections for a gas valve 2 would be provided.

FIG. 2 shows a cross-section of a combined ventilator/gas valve unit 1 with Venturi tube 3.1 and gas flow guiding device 9. Characteristic of the solution according to FIG. 2 is the nozzle 3 established as Venturi tube 3.1, which is, just as in the solution according to FIG. 1, formed on the suction side 4.2 of the ventilator housing 4.1, especially at the cover of the ventilator housing 4.1. The Venturi tube 3.1 is at its distal end provided with a threaded joint 6, by use of which the gas valve 2 is fastened to the Venturi tube 3.1. As it is seen, a first part of the gas valve 2 is within the Venturi tube 3.1, and a second part, limited by the threaded joint 6, of the gas valve 2 is outside the Venturi tube 3.1. The first part of the gas valve 2, located within the Venturi tube 3.1, on the face side is provided with the gas flow guiding device 9 established as cap, extending from the gas outflow side 2.2 of the gas valve 2 up to the threaded joint 6. Hence the gas 10 is subjected to a reversal of the direction of flow. In the area of combination of the cones of the Venturi tube 3.1 directed opposite to each other the gas flow guiding device 9 has an annular gap 9.1, through which the gas 10 is drawn by the air 11 that enters the Venturi tube 3.1. Said annular gap 9.1 can extend almost completely, or only partially, over a perimeter of the gas flow guiding device 9. The air 11 and the gas 10 entrained by the air 11 mix even before entering the ventilator 4, with the nozzle space acting as mixing space 8 for the gases 10, 11. The gas valve 2 is additionally provided with sensors not shown for use in a λ-control circuit or in other control circuits of the firing installation. For example, a sensor established as a pressure sensor, placed in the valve housing 2.1, can be used as interface to the valve's electronic equipment. Further, sensors for flow rate measurement can be provided, located in the area of the Venturi tube 3.1. Use of a Venturi tube 3.1 enhances mixing of the gases 10, 11 that take part in combustion, which enables the combustion to run more efficiently, hence achieving less toxic emissions.

FIG. 3 shows a cross-section of a combined ventilator/gas valve unit 1 with the suction side 4.2 of the ventilator housing 4.1 established as nozzle 3 and a face-side threaded joint 6. As far as the flow pattern of the gas 10 and air 11 are concerned, this solution corresponds to the representation of FIG. 1. The significant difference to the representation of FIG. 1, however, is that the valve housing 2.1 on its gas outflow side 2.2 is provided with an external thread, while the nozzle 3 in the area of the axis of the runner of the ventilator 4 is provided with an internal thread. In this way the threaded joint 6 ensures the attachment of the gas valve 2 to the ventilator 4, or the suction side 4.2 established as nozzle 3 of the ventilator housing 4.1, respectively. The essential advantage of this solution consists in that for fastening the gas valve 2 to the ventilator 4 the gas valve 2 has only to be screwed in so that the user of the combined ventilator/gas valve unit 1 according to the invention is not technologically restricted when selecting a desired gas valve 2. Use of sensors, as described in the solution according to FIG. 1, is also provided in this approach.

FIG. 4 shows a cross-section of a combined ventilator/gas valve unit 1 with Venturi tube 3.1 and gas flow guiding device 9, whereby doing without a separate valve housing 2.1 the faceside end of the Venturi tube 3.1 and the gas valve 2 are connected to each other by means of a threaded joint 6. At its distal end the Venturi tube 3.1 is provided with a threaded joint 6, by use of which the gas valve 2 is fastened to the Venturi tube 3.1. As it is seen, a first part of the gas valve 2 is within the Venturi tube 3.1, and a second part, limited by the threaded joint 6, of the gas valve 2 is outside the Venturi tube 3.1. The first part of the gas valve 2, located within the Venturi tube 3.1, on the face side is provided with the gas flow guiding device 9 established as cap, extending from the gas outflow side 2.2 of the gas valve 2 up to the threaded joint 6. Hence the gas 10 is subjected to a reversal of the direction of flow. In the area of combination of the cones of the Venturi tube 3.1 directed opposite to each other the gas flow guiding device 9 has an annular gap 9.1, through which the gas 10 is drawn in by the air 11 that enters the Venturi tube 3.1. Said annular gap 9.1 can extend almost completely, or only partially, over a perimeter of the gas flow guiding device 9. The air 11 and the gas 10 entrained by the air 11 even mix before the ventilator 4, with the nozzle space acting as mixing space 8 of the gases 10, 11. The essential advantage of this solution consists in that for fastening the gas valve 2 to the ventilator 4 the gas valve 2 has only to be screwed in so that the user of the combined ventilator/gas valve unit 1 according to the invention is not technologically restricted when selecting a desired gas valve 2. The gas valve 2 can be located at any position relative to the ventilator 4, with an axial orientation to the axis of the runner of the ventilator 4 preferred. When the gas valve 2 is, for example, designed of a stepper motor and a solenoid, the stepper motor and the solenoid are mounted between the ventilator cover. Another advantage of this solution is that various sealings are dispensed with and the Venturi tube 3.1 can be designed variable in its length, shape and diameter. The wiring effort—regarding the sensors, valve actors, and DC motor—can be integrated so that the space requirements are further reduced. Use of sensors, as described for FIG. 2, is also provided in this solution.

FIG. 5 shows a cross-section of a combined ventilator/gas valve unit 1 with a gas valve 2 provided with two housing parts in a first version of embodiment. FIG. 5.1 illustrates the accompanying perspective view of the solution according to FIG. 5. Here the first housing part is formed by a formed element 13 present in the ventilator housing 4.1. The formed element 13 is has a contour that largely corresponds to the shape of the gas valve 2. The complementary second housing part of the gas valve 2, however, is established as cover 14 connected to the ventilator housing 4.1. The cover 14 and the part of the ventilator housing 4.1 covered by the cover 14 in assembled condition establish together both the nozzle 3 and a gas flow path entering into the nozzle 3. Therefore the gas valve 2 is placed between its two housing parts 13, 14 that extend in direction of the longitudinal axis of the gas valve 2. In this solution the formed element 13 is arranged directly on the suction side 4.2 of the ventilator 4. The formed element 13, established as first housing part, of the ventilator housing 4.1 and the cover 14 established as second housing part of the gas valve 2 each are established as complementary housing halves.

FIG. 6 shows a cross-section of a combined ventilator/gas valve unit 1 with a gas valve 2 provided with two housing parts 13, 14, in a second version of embodiment. FIG. 6.1 illustrates the accompanying perspective view of the solution according to FIG. 6. Here the first housing part is formed by a formed element 13 present in the ventilator housing 4.1. The formed element 13 is provided with a contour that largely corresponds to the shape of the gas valve 2. The complementary second housing part of the gas valve 2, however, is established as cover 14 connected to the ventilator housing 4.1. The cover 14 and the part of the ventilator housing 4.1 covered by the cover 14 in assembled condition establish together both the nozzle 3 and a gas flow path entering into the nozzle 3. Therefore the gas valve 2 is placed between its two housing parts 13, 14 that extend in direction of the longitudinal axis of the gas valve 2. In this solution the formed element 13 is arranged direct on a face side 4.2 of the ventilator 4. The formed element 13, established as first housing part, of the ventilator housing 4.1 and the cover 14 established as second housing part of the gas valve 2 each are established as complementary housing halves.

The significant advantage of the solutions according to FIGS. 5 and 6 is the simplified design, which results in faster assembly. Due to the fact that already the ventilator housing 4.1, or part of the ventilator housing 4.1, respectively, are used as first housing part of the gas valve 2 and the cover 14 as second housing part of the gas valve 2, and thus the actual nozzle 3 and the gas flow path entering into the nozzle 3 are established only after assembly, the design of the combined ventilator/gas valve unit 1 is significantly simplified, which results in shorter manufacture times. Compared with the solutions according to FIGS. 1 to 4 the tolerance chains and external dimensions of the combined ventilator/gas valve unit 1 additionally could clearly be reduced.

NOMENCLATURE

| | |
|---|---|
| 1 | combined ventilator/gas valve unit |
| 2 | gas valve |
| 2.1 | housing of the gas valve |
| 2.2 | gas outflow side |
| 3 | nozzle |
| 3.1 | Venturi tube |
| 4 | ventilator |
| 4.1 | ventilator housing |
| 4.2 | suction side |
| 5 | fins |
| 6 | threaded joint |
| 7 | air inflow channel |
| 8 | (gas) mixing space |
| 9 | gas flow guiding device |
| 9.1 | annular gap |
| 10 | gas, gas flow |
| 11 | air, air flow |
| 12 | fuel gas, fuel gas flow |
| 13 | formed element |
| 14 | cover |

1-13. (canceled)

14. A combined ventilator/gas valve unit (1), comprising
a gas valve (2) being disposed in a housing (2.1),
a nozzle (3) located behind the housing (2.1), and an adjoining ventilator (4),
the ventilator is provided with a multipart ventilator housing (4.1), with the suction side (4.2) of the ventilator housing (4.1) forming the nozzle (3),
the gas valve (2) is fastened to the nozzle (3).

15. The combined ventilator/gas valve unit (1) according to claim 14, wherein the suction side (4.2) of the ventilator housing (4.1) is formed as housing cover.

16. The combined ventilator/gas valve unit (1) according to claim 14, wherein the fastening of the gas valve (2) to the suction side (4.2) formed as nozzle (3), of the ventilator housing (4.1) is provided by using fins (5) and/or a threaded joint (6).

17. The combined ventilator/gas valve unit (1) according to claim 14, wherein the suction side (4.2) of the ventilator housing (4.1) forming the nozzle (3), and at least part of the housing (2.1) of the gas valve (2) are manufactured as a compact one-part component.

18. The combined ventilator/gas valve unit (1) according to claim 14, wherein the gas valve (2) is arranged concentric in an air inflow channel (7), axial on the suction side (4.2), respectively, of the ventilator (4).

19. The combined ventilator/gas valve unit (1) according to claim 14, wherein the nozzle (3) is a Venturi tube (3.1).

20. The combined ventilator/gas valve unit (1) according to claim 14, wherein the gas valve (2) on the gas outflow side (2.2) is provided with a gas flow guiding device (9) that in the area of combination of nozzle cones of nozzle (3) directed opposite to each other are formed as a Venturi tube (3.1) comprising an annular gap (9.1), through which the gas (10) is drawn by the air (11) flowing into the Venturi tube (3.1) so that the gas (10) and the air (11) are fed to the mixing space (8) placed before the ventilator (4).

21. The combined ventilator/gas valve unit (1) according to claim 20, wherein the gas flow guiding device (9) is formed as cap or as cover.

22. A combined ventilator/gas valve unit (1) comprising
a gas valve (2) disposed in a housing (2.1),
a nozzle (3) located behind the housing, and an adjoining ventilator (4) which is provided with a multipart ventilator housing (4.1), whereby part of the ventilator housing (4.1) and the housing (2.1) of the gas valve (2) are formed such that in assembled condition they together establish both the nozzle (3) and a gas flow path entering into the nozzle (3).

23. The combined ventilator/gas valve unit (1) according to claim 22, wherein the gas valve (2) is formed of two housing parts (13, 14), of which the first housing part is established by a formed element (13) present in the ventilator housing (4.1) and the complementary second housing part (14) of the gas valve (2) is established as a cover (14) that is connected to the ventilator housing (4.1), wherein the cover (14) and the part of the ventilator housing (4.1) that is covered by the cover (14) in assembled condition together establish both the nozzle (3) and a gas flow path entering into the nozzle (3).

24. The combined ventilator/gas valve unit (1) according to claim 22, wherein differently formed top parts are provided that are placed before the nozzle (3) to establish various suction-side air flow profiles, offering the possibility to simply integrate sensors.

25. The combined ventilator/gas valve unit (1) according to claim 22, wherein the formed element (13) is arranged on the suction side (4.2) of the ventilator housing (4.1).

26. Combined ventilator/gas valve unit (1) according to claim 22, wherein the formed element (13), which is formed as a first housing part of the ventilator housing (4.1) and the cover (14), which is formed as a second housing part of the gas valve (2), each are established as complementary housing halves.
